(19) United States
(12) Patent Application Publication
(10) Pub. No.: US 2004/0082307 A1
(43) Pub. Date: Apr. 29, 2004

(54) Mixer circuit

(76) Inventor: Sabine Hackl, Krems/D (AT)

Correspondence Address: BRIGGS AND MORGAN, P.A., 2400 IDS CENTER, MINNEAPOLIS, MN, 55402, US

(21) Appl. No.: 10/434,325

(22) Filed: Jun. 9, 2003

(30) Foreign Application Priority Data
May 15, 2002 (DE) 102 21 620.7-35

(51) Int. Cl. H04B 1/26; H04B 15/00

(52) U.S. Cl. 455/318; 455/313

(57) ABSTRACT

A mixer circuit has an additional capacitance connected between the emitters of the input transistor pair to which the RF input signal is applied.

The invention relates to a mixer circuit.

A mixer circuit is required primarily in radio frequency technology, for example in an RF data transmission system, for the purpose of frequency conversion.

In order to meet the demand for more and more bandwidth in such a data transmission system, ever higher frequency bands are being resorted to. One of the key components in such a data transmission system is therefore a mixer circuit, which is required for frequency conversion into these high bands in the transmitter and for inverse transformation back into baseband in the receiver.

A high mixing gain and a low noise are desirable in such a case in order to be able to amplify even small input signals to a sufficient extent.

A known mixer circuit may be a passive mixer circuit with diodes or other passive components. As an alternative, a known mixer circuit may be an active mixer circuit with transistors.

Active mixers are widespread in applications in data transmission systems. Numerous different configurations are known in this case for the detailed form of circuitry.

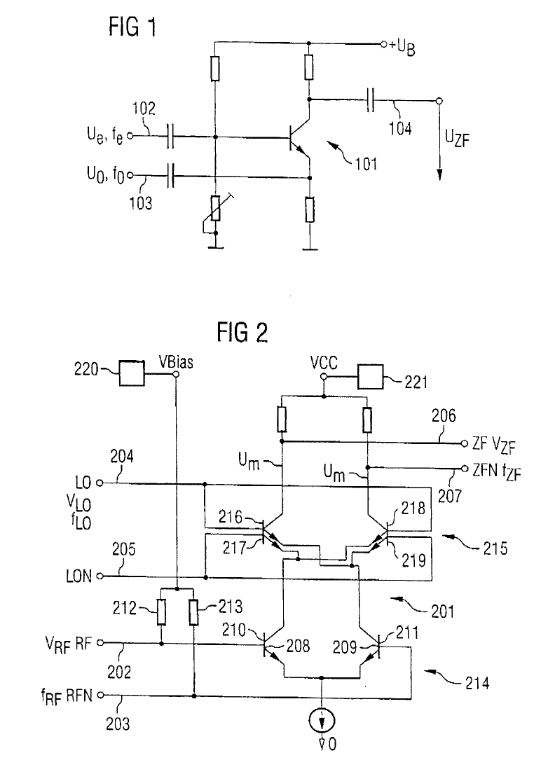

A known active mixer circuit of very simple construction is the additive mixer circuit, illustrated in FIG. 1. A first signal Uₑ with a first frequency fₑ is input into the mixer circuit 101 via a first input 102. A second signal U₀ with a second frequency f₀ is input into the mixer circuit 101 via a second input 103. Mixed signals with different differential frequencies fₘᵢⱼ, i.e.

fₘ₁₁=|fₑ±f₀|, fₘ₂₁=|2fₑ±f₀|, fₘ₁₂=|fₑ±2f₀| etc. (1)

are generated in the mixer circuit 101.

The mixed signals are output at the output 104 of the mixer circuit 101.

A known active mixer circuit that is widespread in applications, for example in data transmission, is the Gilbert cell, which is named after Barrie Gilbert and whose construction is illustrated in FIG. 2.

A mixer circuit 201 set up as a Gilbert cell has a signal input with a first signal terminal RF 202 and a second signal terminal RFN 203, a local oscillator input with a first local oscillator terminal LO 204 and a second local oscillator terminal LON 205, and an intermediate frequency output with a first intermediate frequency terminal ZF 206 and a second intermediate frequency terminal ZFN 207.

The mixer circuit 201 furthermore has an input subcircuit 214 with a first transistor 208 and a second transistor 209, and a local oscillator subcircuit 215 with a third transistor 216, a fourth transistor 217, a fifth transistor 218 and a sixth transistor 219. The first transistor 208 and the second transistor 209 are directly electrically coupled to one another at their emitter terminals. The collector terminal of the first transistor 208 is electrically coupled to the emitter terminal of the fifth transistor 218 and to the emitter terminal of the fourth transistor 217. The collector terminal of the second transistor 209 is electrically coupled to the emitter terminal of the third transistor 216 and to the emitter terminal of the sixth transistor 219.

The first signal terminal RF 202 is electrically coupled to the base terminal 210 of the first transistor 208. The second signal terminal RF 203 is electrically coupled to the base terminal 211 of the second transistor 209.

The first local oscillator terminal LO 204 is electrically coupled to the base terminal of the third transistor 216 and to the base terminal of the fifth transistor 218. The second local oscillator terminal LON 205 is electrically coupled to the base terminal of the fourth transistor 217 and to the base terminal of the sixth transistor 219.

The first intermediate frequency terminal ZF 206 is electrically coupled to the collector terminal of the third transistor 216 and to the collector terminal of the fourth transistor 217. The second intermediate frequency terminal ZFN 207 is electrically coupled to the collector terminal of the fifth transistor 218 and to the collector terminal of the sixth transistor 219.

Connected in parallel with the first signal terminal RF 202 is a first input resistor 212, by means of which a bias voltage V_{Bias} can be applied to the base terminal of the first transistor 208 for the purpose of setting the operating point of the first transistor 208.

Connected in parallel with the second signal terminal RFN 203 is a second input resistor 213, by means of which the bias voltage V_{Bias} can be applied to the base terminal of the second transistor 209 for the purpose of setting the operating point of the second transistor 209.

Either a separate resistor or the internal resistance of a voltage source which provides the bias voltage V_{Bias} may be used as input resistor 212. Either a separate resistor or the internal resistance of a first voltage source 220 which provides the bias voltage V_{Bias} may be used as input resistor 213.

Via the two signal terminals RF 202 and RFN 203, a radio frequency input signal V_{RF} with a signal frequency f_{RF} is fed, depending on the polarity of the radio frequency input signal, to the base terminal 210 of the first transistor 208 or the base terminal 211 of the second transistor 209 of the mixer circuit 201. 15

Via the two local oscillator terminals LO 204 and LON 205, a local oscillator signal V_{LO} with a local oscillator frequency f_{LO} is fed, depending on the polarity of the local oscillator signal, to the base terminal of the third transistor 216 and the base terminal of the fifth transistor 218 or the base terminal of the fourth transistor 217 and the base terminal of the sixth transistor 219 of the mixer circuit 201. Moreover, a supply voltage V_{CC} from a second voltage source 221 is applied via load resistors to the collector terminal of the third transistor 216 and to the collector terminal of the fourth transistor 217, or to the collector terminal of the fifth transistor 218 and to the collector terminal of the sixth transistor 219.

In the mixer circuit 201, as in the case of the additive mixer circuit, a mixed signal Uₘ is generated from the radio frequency input signal V_{RF} and the local oscillator signal V_{LO}, which mixed signal can be output at the first intermediate frequency terminal ZF 206 of the intermediate frequency output by means of the collector terminal of the third transistor 216 and by means of the collector terminal of the fourth transistor 217 and can be output at the second intermediate frequency terminal ZFN 207 of the intermediate frequency output by means of the collector terminal of the fourth transistor 218 and by means of the collector terminal of the sixth transistor 219.

The desired useful signal in the mixed signal is usually the intermediate frequency signal V_{ZF} with the frequency

f_{ZF}=|f_{RF}−f_{LO}|. (2)

The logarithmic voltage ratio of intermediate frequency signal V_{ZF} and input signal V_{RF} is designated as the gain G of the mixer circuit for the intermediate frequency signal. The gain G of the mixer circuit is dependent on frequency.

The frequency operating range is the frequency range in which the mixer circuit attains a gain G sufficient for its expedient operation. The (upper) 3 dB limiting frequency of the mixer circuit is the frequency at which the logarithmic voltage ratio between the output signal Uₘ or V_{ZF} and the input signal V_{RF} is −3 dB, and provides a starting point for the frequency operating range.

At the operating point of the mixer circuit, the gain G has a maximum value Gₘₐₓ at a maximum frequency fₘₐₓ within the frequency operating range.

The frequency operating range and the operating point, i.e. the maximum frequency fₘₐₓ, can usually be set to a limited extent by means of the circuit layout.

It is desirable, in the case of a mixer circuit, to increase the gain and the bandwidth, and as far as possible not to impair the noise figure, i.e., to put it another way, the signal-to-noise ratio, and even if possible to improve it.

Furthermore, [1] describes a Gilbert cell in which a nonreactive resistor or an inductance is connected between the emitter terminals of the bipolar transistors of the input subcircuit, whereby the linearity of the Gilbert cell is intended to be improved.

[2] describes a mixer circuit in which a low-pass filter is connected between a controlled terminal of a first input signal transistor and a controlled terminal of a second input signal transistor. The low-pass filter serves for suppressing undesirable harmonic spectral components.

Furthermore, [3] describes a further mixer circuit with a capacitive element as replacement for a parasitic inductance.

The invention is based on the problem of specifying a mixer circuit which has a higher gain and a larger bandwidth.

The problem is solved by means of a mixer circuit arrangement having the features in accordance with the independent patent claim.

A mixer circuit for mixing an input signal with an input frequency and a local oscillator signal with a local oscillator frequency for the purpose of generating an intermediate frequency signal with an intermediate frequency has a signal input, to which the input signal can be applied, i.e. fed to the mixer circuit, the signal input having a first signal terminal and a second signal terminal. At least a first input signal transistor and a second input signal transistor are provided in an input subcircuit of the mixer circuit. Each input signal transistor has a control terminal, to put it another way a control input, and also two controlled terminals. The control input of the first input signal transistor is coupled to the first signal terminal and the control input of the second input signal transistor is coupled to the second signal terminal, so that the differential input signal, i.e. the radio frequency input signal V_{RF} with a signal frequency f_{RF} can be fed to the two control inputs of the input signal transistors. The mixer circuit furthermore has a local oscillator input for inputting the local oscillator signal into the mixer circuit and also an intermediate frequency output for outputting the intermediate frequency signal. A capacitance, for example a capacitor, is coupled between a first controlled terminal of the first input signal transistor and a first controlled terminal of the second input signal transistor.

The capacitance is thus connected between the two first controlled terminals of the input signal transistors of the input subcircuit of the mixer circuit, the first controlled terminals not being coupled to the transistors of the local oscillator subcircuit of the mixer circuit, i.e. the first controlled terminals are those controlled terminals of the input signal transistors which are arranged on that side of the mixer circuit which is remote from the local oscillator subcircuit, preferably on the grounding side from the standpoint of the input subcircuit. The second controlled terminals of the input signal transistors are coupled to the transistors of the local oscillator subcircuit for the purpose of mixing the input signal with the local oscillator signal.

The mixer circuit according to the invention has a considerably increased 3 dB bandwidth compared with the mixer circuit described in [1], and also a higher mixing gain.

The noise figure of the mixer circuit according to the invention is also considerably reduced compared with the known mixer circuit.

The mixer circuit arrangement according to the invention additionally has the advantage that it is simple, reliable and powerful.

It has been found, in the case of a mixer circuit according to the invention, that, in comparison with a structurally identical mixer circuit without the capacitance, the maximum 3 dB bandwidth is increased from 14-38 GHz to 12-42 GHz, with a simultaneous maximum increase in the mixing gain from 17 dB to 26 dB. Consequently, in this case, an improvement by 6 GHz was achieved with regard to the maximum 3 dB bandwidth and by 9 dB with regard to the mixing gain. The minimum noise figure was improved by 3.3 dB from 16.3 dB to 13 dB in the case measured.

Clearly, the invention can be seen in the fact that the additional capacitance between the first controlled terminals of the transistors of the input subcircuit together with inductively acting components of the mixer circuit forms a resonance, thereby increasing the mixing gain and the bandwidth and reducing the noise figure.

Preferred developments of the invention emerge from the dependent claims.

In accordance with one configuration of the invention, the mixer circuit is set up in a fully differential manner. Preferably, the local oscillator input of the mixer circuit thus has a first local oscillator terminal and a second local oscillator terminal. In accordance with this refinement of the invention, the intermediate frequency output has a first intermediate frequency terminal and a second intermediate frequency terminal.

A highly cost-effective mixer circuit that can be produced in a simple manner results in the case of a configuration of the mixer circuit as a Gilbert cell.

In accordance with one development of the invention, at least some of the transistors are configured as bipolar transistors, in which case preferably the first input signal transistor and the second input signal transistor are bipolar transistors. In this case, the control input of the first input signal transistor is the base terminal of the first input signal transistor and the control input of the second input signal transistor is the base terminal of the second input transistor. In this case, the first controlled terminal of the first input signal transistor is the emitter terminal of the first input signal transistor and the first controlled terminal of the second input signal transistor is the emitter terminal of the second input signal transistor in this case. The transistors may be configured as pnp bipolar transistors or, as an alternative, as npn bipolar transistors.

To put it another way, this means that, in accordance with this configuration of the invention, the capacitance is connected between the emitters of the two bipolar transistors of the input subcircuit of the mixer circuit, i.e. between the emitters of the transistor pair to whose base terminals the RF input signal is applied.

As an alternative, at least some of the transistors may be set up as MOS field-effect transistors (Metal Oxide Semiconductor field-effect transistors). In this case, the MOS field-effect transistors may be configured as n-channel MOS field-effect transistors or as p-channel MOS field-effect transistors.

In this case, preferably the first input signal transistor and the second input signal transistor are set up as MOS field-effect transistors and the control input of the first input signal transistor is the gate terminal of the first input signal transistor. The control input of the second input signal transistor is the gate terminal of the second input signal transistor. In this case, the first controlled terminal of the first input signal transistor is a first source/drain terminal, preferably the source terminal, of the first input signal transistor and the first controlled terminal of the second input signal transistor is a first source/drain terminal, preferably the source terminal, of the second input signal transistor in this case.

In accordance with one development of the invention, the mixer circuit is formed at least partially as a monolithic integrated circuit, preferably based on silicon.

This enables the mixer circuit to be realized in a very simple and cost-effective manner.

As an alternative, the mixer circuit with its transistors and, if appropriate, other components is provided as housed or unhoused individual devices which are soldered together, for example on a circuit board, in accordance with the desired functionality.

In principle, any desired technologies are possible as technology(ies) on which the monolithic large-scale integrated circuit is based. By way of example, the mixer circuit arrangement may be based at least partially on silicon, or it may be based at least partially on a compound semiconductor, for example with a III-V semiconductor such as GaAs, InP, InSb or one or more other known III-V semiconductors, or on a II-VI semiconductor, or on SiGe. BiCMOS, CMOS or other known technologies are possible technologies for realizing the circuit arrangement.

A very fast mixer circuit is produced for the case where it is realized in a manner based at least partially on SiGe technology.

Exemplary embodiments of the invention are illustrated in the figures and are explained in more detail below.

In the figures:

FIG. 1 Shows a circuit diagram of an additive mixer circuit in accordance with the prior art;

FIG. 2 Shows a circuit diagram of a Gilbert cell in accordance with the prior art;

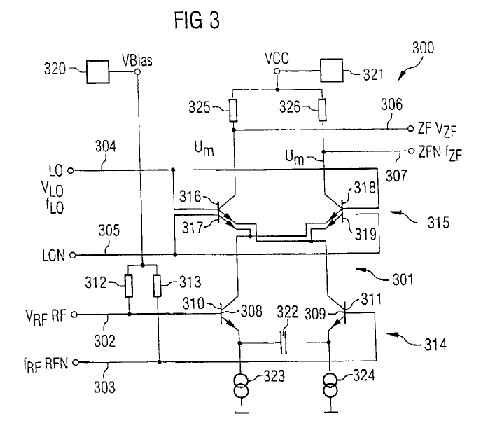

FIG. 3 Shows a circuit diagram of a mixer circuit in accordance with a first exemplary embodiment of the invention;

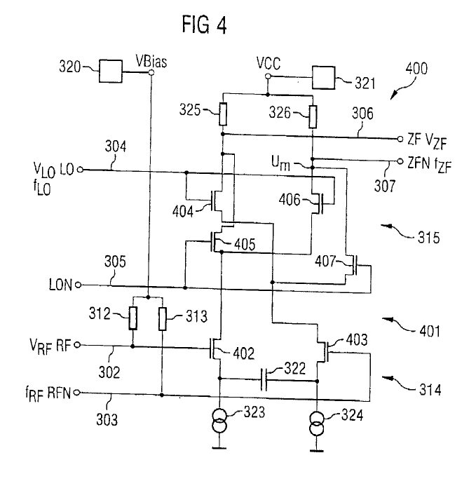

FIG. 4 Shows a circuit diagram of a mixer circuit in accordance with a second exemplary embodiment of the invention;

FIG. 5 Shows a sketch illustrating the mixing gain determined as a function of the signal frequency of the input signal in the case of a mixer circuit configured in accordance with FIG. 3, and the mixing gain in the case of an otherwise structurally identical mixer circuit without the additional capacitance between the emitters of the transistors of the input subcircuit; and

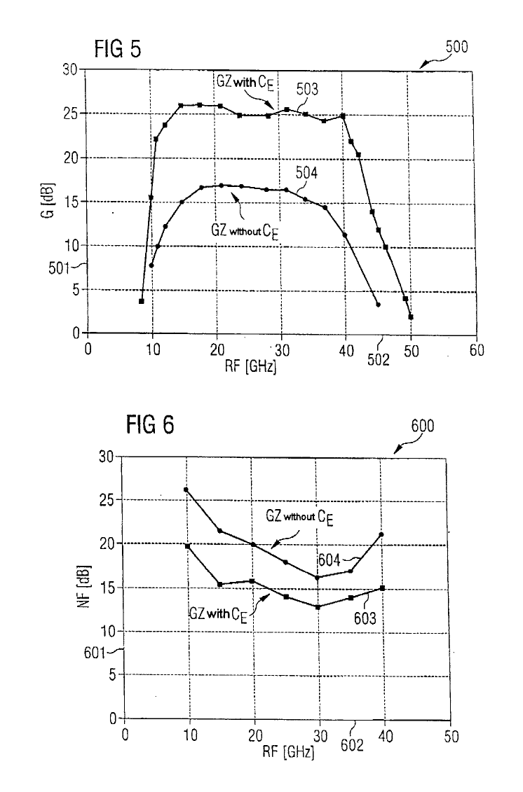

FIG. 6 Shows a sketch illustrating the double sideband noise figure determined as a function of the signal frequency of the input signal in the case of a mixer circuit configured in accordance with FIG. 3, and the double sideband noise figure in the case of an otherwise structurally identical mixer circuit without the additional capacitance between the emitters of the transistors of the input subcircuit.

FIG. 3 shows a sketch of a mixer circuit arrangement 300 in accordance with a first exemplary embodiment of the invention.

A mixer circuit set up as a Gilbert cell is provided in the mixer circuit arrangement.

In a transistor in a figure of the drawing, generally the emitter terminal is identified by an arrow.

The mixer circuit arrangement 300 has a Gilbert cell as mixer circuit 301 and also a signal input with a first signal terminal RF 302 and a second signal terminal RFN 303, a local oscillator input with a first local oscillator terminal LO 304 and a second local oscillator terminal LON 305 and an intermediate frequency output with a first intermediate frequency terminal ZF 306 and a second intermediate frequency terminal ZFN 307.

The mixer circuit 301 has an input subcircuit 314 with a first transistor 308 and a second transistor 309, and a local oscillator subcircuit 315 with a third transistor 316, a fourth transistor 317, a fifth transistor 318 and a sixth transistor 319.

The emitter terminal of the first transistor 308 is coupled to a first terminal of a capacitance 322, whose second terminal is coupled to the emitter terminal of the second transistor 309.

Furthermore, the first terminal of the capacitance 322 is coupled to a first terminal of a first current source 323, whose second terminal is connected to the ground potential. The second terminal of the capacitance 322 is coupled to a first terminal of a second current source 324, whose second terminal is likewise connected to the ground potential. The capacitance 322 has a value of 1 pF in accordance with this exemplary embodiment.

The collector terminal of the first transistor 308 is electrically coupled to the emitter terminal of the fifth transistor 318 and to the emitter terminal of the fourth transistor 317. The collector terminal of the second transistor 309 is electrically coupled to the emitter terminal of the third transistor 316 and to the emitter terminal of the sixth transistor 319.

The first signal terminal RF 302 is electrically coupled to the base terminal 310 of the first transistor 308. The second signal terminal RF 303 is electrically coupled to the base terminal 311 of the second transistor 309.

The first local oscillator terminal LO 304 is electrically coupled to the base terminal of the third transistor 316 and to the base terminal of the fifth transistor 318. The second local oscillator terminal LON 305 is electrically connected to the base terminal of the fourth transistor 317 and to the base terminal of the sixth transistor 319.

The first intermediate frequency terminal ZF 306 is electrically coupled to the collector terminal of the third transistor 316 and the collector terminal of the fourth transistor 317. The second intermediate frequency terminal ZFN 307 is electrically coupled to the collector terminal of the fifth transistor 318 and the collector terminal of the sixth transistor 319.

Connected in parallel with the first signal terminal RF 302 is a first input resistor 312, by means of which a bias voltage V_{Bias} can be applied to the base terminal of the first transistor 308 for the purpose of setting the operating point of the first transistor 308.

Connected in parallel with the second signal terminal RFN 303 is a second input resistor 313, by means of which the bias voltage V_{Bias} can be applied to the base terminal of the second transistor 309 for the purpose of setting the operating point of the second transistor 309.

Either a separate resistor or the internal resistance of a first voltage source 320 which provides the bias voltage V_{Bias} may be used as input resistor 312. Likewise, either a separate resistor or the internal resistance of the first voltage source 320 which provides the bias voltage V_{Bias} may be used as input resistor 313.

The resistance of the two input resistors 312 and 313 is 50 ohms in each case. In an alternative embodiment of the mixer circuit arrangement according to the invention, the resistance of the two input resistors 312 and 313 is 200 ohms in each case, and 300 ohms in each case in a further embodiment.

Via the two signal terminals RF 302 and RFN 303, a radio frequency input signal V_{RF} with a signal frequency f_{RF} is fed, depending on the polarity of the radio frequency input signal, to the base terminal 310 of the first transistor 308 or the base terminal 311 of the second transistor 309 of the mixer circuit 301.

Via the two local oscillator terminals LO 304 and LON 305, a local oscillator signal V_{LO} with a local oscillator frequency f_{LO} is fed, depending on the polarity of the local oscillator signal, to the base terminal of the third transistor 316 and the base terminal of the fifth transistor 318 or the base terminal of the fourth transistor 317 and the base terminal of the sixth transistor 319 of the mixer circuit 301. Moreover, a supply voltage V_{CC} from a second voltage source 321 is applied via load resistors 325, 326 to the collector terminal of the third transistor 316 and to the collector terminal of the fourth transistor 317, or to the collector terminal of the fifth transistor 318 and to the collector terminal of the sixth transistor 319.

In the mixer circuit 301, as in the case of the additive mixer circuit, a mixed signal Uₘ is generated from the radio frequency input signal V_{RF} and the local oscillator signal V_{LO}, which mixed signal can be output at the first intermediate frequency terminal ZF 306 of the intermediate frequency output by means of the collector terminal of the third transistor 316 and by means of the collector terminal of the fourth transistor 317 and can be output at the second intermediate frequency terminal ZFN 307 of the intermediate frequency output by means of the collector terminal of the fourth transistor 318 and by means of the collector terminal of the sixth transistor 319.

The desired useful signal in the mixed signal is usually the intermediate frequency signal V_{ZF} with the frequency

f_{ZF}=|f_{RF}−f_{LO}|. (2)

In accordance with the first exemplary embodiment, the transistors are set up as silicon-germanium bipolar transistors. The mixer circuit in accordance with this embodiment is distinguished by a particularly high operating frequency.

FIG. 4 shows a sketch of a mixer circuit arrangement 400 in accordance with a second exemplary embodiment of the invention.

The mixer circuit arrangement 400 in accordance with the second exemplary embodiment of the invention essentially corresponds to the mixer circuit arrangement 300 in accordance with the first exemplary embodiment of the invention, for which reason identical elements are provided with identical reference symbols in the figures.

The mixer circuit arrangement 400 in accordance with the second exemplary embodiment of the invention differs from the mixer circuit arrangement 300 in accordance with the first exemplary embodiment of the invention essentially in that the transistors of the mixer circuit 401, i.e. the first transistor 402, the second transistor 403, the third transistor 404, the fourth transistor 405, the fifth transistor 406 and the sixth transistor 407, are formed as MOS field-effect transistors.

In accordance with this exemplary embodiment, the capacitance 322 is coupled between the source terminals of the first transistor 402 and of the second transistor 403.

The mixer circuit according to the invention is suitable in particular for use in signal processing at high carrier frequencies, for example in the case of point-to-multipoint communication links at 10.5 GHz, at 24 GHz or at 26 GHz or in the case of LMDS (Local Multipoint Distribution System) at 28 GHz and 38 GHz and MVDS (Multipoint Video Distribution Systems) at 42 GHz.

FIG. 5 shows a diagram 500 illustrating the measured mixing gain G 501 as a function of the signal frequency RF 502 of the RF input signal in the case of a mixer circuit 301 configured in accordance with FIG. 3 (as a first mixing gain curve 503), and the mixing gain G 501 in the case of a mixer circuit without the additional capacitance between the emitters of the transistors of the input subcircuit, with an otherwise identical structure (as a second mixing gain curve 504).

As can be gathered from FIG. 5, it has been found that, in comparison with a structurally identical mixer circuit without the capacitance, the maximum 3 dB bandwidth is increased according to the invention from 14-38 GHz to 12-42 GHz, with a simultaneous maximum increase in the mixing gain from 17 dB to 26 dB. Consequently, in this case, an improvement by 6 GHz has been achieved with regard to the maximum 3 dB bandwidth and by 9 dB with regard to the mixing gain.

FIG. 6 shows a diagram 600 illustrating the measured double sideband noise figure NF 601 as a function of the signal frequency RF 602 of the RF input signal in the case of a mixer circuit 301 configured in accordance with FIG. 3 (as a first noise figure curve 603) and the double sideband noise figure NF 601 in the case of a mixer circuit without the additional capacitance between the emitters of the transistors of the input subcircuit, with an otherwise identical structure (as a second mixing gain curve 604).

As can be gathered from FIG. 6, it has been found that, in comparison with a structurally identical mixer circuit without the capacitance, the minimum noise figure has been improved by 3.3 dB from 16.3 dB to 13 dB in the case measured.

Clearly, the invention can be seen in the fact that an additional capacitance is connected between the emitters of the transistor pair at the RF signal input of a mixer, preferably of a Gilbert mixer, and, together with inductively acting components in the mixer, forms a resonance, whereby the mixing gain and the 3 dB bandwidth are increased and the noise figure is reduced.

The following publication is cited in this document:

[1] B. Gilbert, Mixer Fundamentals and Active Mixer Design, Electronics Laboratories Advanced Engineering Course on RF IC Design for Wireless Communication Systems, Lausanne, Switzerland, pp. 57-61, Jul. 3-7, 1995

[2] DE 197 08 007 A1

[3] U.S. Pat. No. 5,379,457

1. A mixer circuit (201) for mixing an input signal (VRF) with an input frequency (fRF) and a local oscillator signal (VLO) with a local oscillator frequency (fLO) of generating an intermediate frequency signal (ZF) with an intermediate frequency (fZF),
having a signal input for inputting the input signal (VRF), the signal input having a first signal terminal and a second signal terminal (RF 202, RFN 203),
having a first input signal transistor, whose control input is coupled to the first signal terminal,
having a second input signal transistor, whose control input is coupled to the second signal terminal,
having a local oscillator input for inputting the local oscillator signal (VLO) into the mixer circuit (201), and
having an intermediate frequency output for outputting the intermediate frequency signal (VZF),
having a capacitance between a first controlled terminal of the first input signal transistor and a first controlled terminal of the second input signal transistor.

2. The mixer circuit (201) as claimed in claim 1, in which
the local oscillator input has a first and a second local oscillator terminal (LO 204, LON 205), and
the intermediate frequency output has a first and a second intermediate frequency terminal (ZF 206, ZFN 207).

3. The mixer circuit (201) as claimed in claim 1 or 2, set up as a Gilbert cell.

4. The mixer circuit (201) as claimed in one of claims 1 to 3, in which at least some of the transistors are bipolar transistors.

5. The mixer circuit (201) as claimed in claim 4, in which the first input signal transistor and the second input signal transistor are bipolar transistors,
in which the control input of the first input signal transistor and of the second input signal transistor is in each case the base terminal thereof, and
in which the first controlled terminal of the first input signal transistor and of the second input signal transistor is in each case the emitter terminal thereof.

6. The mixer circuit (201) as claimed in one of claims 1 to 3, in which at least some of the transistors are MOS field-effect transistors.

7. The mixer circuit (201) as claimed in claim 6,
in which the first input signal transistor and the second input signal transistor are MOS field-effect transistors,
in which the control input of the first input signal transistor and of the second input signal transistor is in each case the gate terminal thereof,
in which the first controlled terminal of the first input signal transistor and of the second input signal transistor is in each case the source terminal thereof.

8. The mixer circuit (201) as claimed in one of claims 1 to 7, which is formed at least partially as a monolithic integrated circuit.

9. The mixer circuit (201) as claimed in claim 8, which is based at least partially on silicon.

10. The mixer circuit (201) as claimed in claim 8, which is based at least partially on at least one compound semiconductor.

11. The mixer circuit (201) as claimed in claim 9 or 10, which is based at least partially on BiCMOS technology.

12. The mixer circuit (201) as claimed in claim 9 or 10, which is based at least partially on CMOS technology.

13. The mixer circuit (201) as claimed in claim 9 or 10, which is based at least partially on SiGe technology.
